(19) United States
(12) Patent Application Publication
(10) Pub. No.: US 2015/0325351 A1
(43) Pub. Date: Nov. 12, 2015

(54) HIGH-PERMEABILITY AMORPHOUS COMPRESSED POWDER CORE BY MEANS OF HIGH-TEMPERATURE MOLDING, AND METHOD FOR PREPARING SAME

(71) Applicant: Eun-Young BAE, Gumi-si, Gyeongsangbuk-do (KR)

(72) Inventor: Kyu-Jin KIM, Daejeon (KR)

(21) Appl. No.: 14/649,488

(22) PCT Filed: Nov. 25, 2013
(86) PCT No.: PCT/KR2013/010731

§ 371 Date: Jun. 3, 2015

(30) Foreign Application Priority Data
Dec. 4, 2012 (KR) 10-2012-0139429

(51) Int. Cl. H01F 1/153; B22F 3/24; H01F 1/24; B22F 1/00; H01F 41/02; B22F 3/14; B22F 1/02

(52) U.S. Cl. CPC H01F 1/15308; B22F 3/14; B22F 3/24; B22F 1/02; B22F 1/007; H01F 41/02; H01F 1/1535; H01F 1/15383; H01F 1/15316; H01F 1/24; B22F 2003/248

(57) ABSTRACT

In the present invention, according to a method for preparing a high-permeability amorphous compressed powder core having a small variable range of effective permeability even at a high frequency band by means of high-temperature molding, it is possible to prepare an amorphous compressed powder core having a small variable range of effective permeability even at a high frequency band, an effective permeability of 75 or more, and a significantly small core loss of 300 mW/cc or less under conditions in which the frequency is 50 KHz and the induced magnetic flux is 1,000 Gauss, by coating twice, i.e. with phosphoric acid coating and polyimide-based coating as insulators between powders, and then automatic compression molding at a temperature of about 200 to 550′C by using molybdenum disulfide (MoS₂) or graphite powder which can be lubricated at a high temperature.

### TECHNICAL FIELD

The present invention relates to a high-permeability amorphous compressed powder core by means of high temperature molding and a method for preparing the same, wherein the high-permeability amorphous compressed powder core is applicable to a frequency band of several kHz to several tens of MHz by means of automatic molding at a high temperature of 200 to 550° C., which was not possible in the prior art, and has an effective permeability of 75 or more.

### BACKGROUND ART

Generally, soft magnetic amorphous alloys have excellent permeability, core loss, and the like compared with crystalline materials, and are thus being used as a magnetic material for a variety of devices in electrical and electronic applications, and applied to industrial applications such as transformers, inductors, motors, generators, and relays.

Soft magnetic amorphous alloy powder may be generally prepared by means of mechanical alloying, rapid solidification, water atomization, or the like, and the present invention employed high-pressure water atomization. In the case of the high-pressure water atomization, there was applied and registered a method for preparing soft magnetic amorphous alloy particulate powder having an average particle size of 30 μm or less by pulverizing and quenching falling molten metal by injecting high pressurized water at 30 MPa or more, the method being disclosed in Korean Patent Registration No. 10-037226 as an invention devised by the present inventor. Particularly, an amorphous alloy nano-crystallized by heat-treating a soft magnetic amorphous alloy at around crystallization temperature has very excellent soft magnetic properties compared with an amorphous alloy heat-treated below the crystallization temperature.

In addition, examples of amorphous alloy powder systems promising nano-crystallization by proper heat-treatment include Fe—Si—B systems, Fe—Al—B systems, and Fe—Nb—B systems. Crystallization temperature of these alloys is around about 400 to 500° C.

Delayed commercialization in spite of such excellent soft magnetic properties results from high strength and high toughness of the amorphous alloy itself. Generally, effective permeability which can be obtained by room-temperature molding is at most about 60. Therefore, a method for preparing an amorphous compressed powder core at room temperature was applied and registered, the method being disclosed in Korean Patent Registration No. 10-0344010 as an invention devised by the present inventor.

The reason that permeability is not high as described above results from that molding density is only about 70% of true density, and one way to solve this problem is to increase molding temperature. However, as a prerequisite to this end, typical lubricants cannot be used, a lubricant that can withstand the high temperature is needed, and an improvement in insulation properties has been required according to the increase in compressed density by molding.

Furthermore, binders used for preparing a core using soft magnetic amorphous alloy powder should have a softening point lower than the crystallization temperature of the amorphous alloy, and should have proper bonding strength even at room temperature so that cracks may be prevented from being generated while maintaining the shape of core itself according to molding pressure at room temperature. It is preferable that polyimide-based and phenol-based thermosetting resins are used as a suitable binder to this end.

Meanwhile, the molding process for soft magnetic amorphous alloy powder should be performed below the crystallization temperature of the alloy in order to maintain the amorphous state of the alloy. However, it is impossible to mold alloy powder at this temperature, so that there is employed a method of bonding soft magnetic amorphous alloy powder in such a way that glass powder having a low softening point is mechanically mixed with the soft magnetic amorphous alloy powder using a ball mill method or the like and the glass powder is then softened and pressurized at a high temperature around about 500° C. An Example of applicable experimental molding methods is hot isostatic pressing. In addition, an explosive method, a stun gun method, and the like are applicable, but these methods all have problems in that a special apparatus is necessary for obtaining very high energy, and particularly, molding time is excessively required and continuous production is not possible, and mass production is thus also impossible.

In order to solve these problems, in the present invention, true density of an amorphous compressed powder core may reach up to 85% by developing manufacturing technique for high-temperature automatic molding at a temperature range of 200 to 550° C. Furthermore, the present invention relates to a high-permeability amorphous compressed powder core by means of high-temperature molding and a method for preparing the same, wherein the high-permeability amorphous compressed powder core may be used at a frequency band of several kHz to several tens of MHz by means of automatic molding technique, which was not possible in the prior art.

### DISCLOSURE OF THE INVENTION

### Technical Problem

The purpose of the present invention is to provide a method for preparing a high-permeability amorphous compressed powder core by means of high-temperature molding, wherein it is possible to perform automatic compression molding at a temperature range of 200 to 550° C. in such a way that composite powder is prepared by coating twice in order to improve insulation properties of soft magnetic amorphous alloy powder and bonding force during the molding, and a metal oxide-based lubricant maintaining lubricity even at a high temperature is then applied, so that the high-permeability amorphous compressed powder core may be prepared by molding press used in typical room-temperature molding, and the variable range of effective permeability is small even at a high frequency band.

Another purpose of the present invention is to provide a high-permeability amorphous compressed powder core by means of high-temperature molding, wherein the high-permeability amorphous compressed powder core according to the above method has high molding density and no surface crack, has good insulation properties among particles so as to be less dependent on frequency, and also has a small variable range of effective permeability even at a high frequency band.

### Technical Solution

In order to solve the above technical problem, a method for preparing a high-permeability amorphous compressed powder core having a small variable range of effective permeability even at a high frequency band by means of high-temperature molding according to the present invention includes: (a) performing liquid-phase coating sequentially twice on soft magnetic amorphous alloy powder using a phosphoric acid and a polyimide-based resin in an amount of 0.5 to 3.0 wt % to prepare composite particulate powder having a uniform and dense coated layer; (b) homogeneously mixing the composite particulate powder with fine molybdenum disulfide (MoS₂) or graphite powder as a lubricant in an amount of 0.5 to 3.0 wt %; (c) molding the mixed powder at a high temperature; and (d) performing heat-treatment.

It is characterized in that the molding is performed at a temperature of 200 to 550° C. under a pressure of 10 to 25 ton/cm², and the heat-treatment of the core is performed at a temperature of 400 to 600° C.

The soft magnetic amorphous alloy powder is Fe-based powder, Ni-based powder, Co-based powder, or the like, and the amount of each of the coating is suitably 0.5 to 3.0 wt % of the total weight.

In order to solve the other purpose, a high-permeability amorphous compressed powder core obtained by the method for preparing a high-permeability amorphous compressed powder core having a small variable range of effective permeability even at a high frequency band by means of high-temperature molding according to the present invention is characterized by being prepared so that the effective permeability is 75 or more, the permeability ratio measured at frequency bands of 1 MHz and 0.1 MHz is 0.90 or more, and the core loss is 300 mW/cc or less under conditions in which the frequency is 50 kHz and the induced magnetic flux is 1,000 Gauss.

Hereinafter, the present invention will be described in detail.

Generally, soft magnetic amorphous alloy powder may be prepared by means of mechanical alloying, rapid solidification, water atomization, or the like, and the present invention employed powder prepared by high-pressure water atomization. Particularly, examples of alloy powder systems promising the use as the amorphous state include Fe-based systems (Fe—Si—B systems, Fe—Al—B systems, Fe—Nb—B systems, and the like) and Co-based systems (Co—Fe—Si—B systems). Crystallization temperature of these alloys is around about 400 to 500° C.

In the present invention, it is preferable that coating is performed twice in order to improve insulation properties of soft magnetic amorphous alloy powder and bonding force during the molding. A phosphoric acid was applied as a primary coating agent in the present invention. The amount of the phosphoric acid coating is suitably 0.5 to 3.0 wt % of the total weight. When the amount is less than 0.5 wt %, the insulation properties are deteriorated. On the other hand, when the amount is greater than 3.0 wt %, soft magnetic properties are significantly deteriorated. A secondary coating agent in the present invention should have a softening point lower than heat-treatment temperature of the amorphous alloy in order to improve insulation properties and bonding force during the molding, and should have proper bonding strength even at a temperature of 200 to 550° C., so that cracks may be prevented from being generated while maintaining the shape of core itself according to molding pressure. Polyimide-based and phenol-based thermosetting resins are preferable as a suitable binder. Generally, even if water glass used in preparing a compressed powder core is added up to 3.0 wt % (weight percentage) of the total weight, bonding strength between powder particles is weak and it is thus not suitable. It is preferable that the amount of the binder in the present invention is limited to 0.5 to 3.0 wt % of the total weight. When the amount of the binder is less than 0.5 wt % of the total weight, it is difficult to mold amorphous alloy powder due to weak bonding strength. On the other hand, when the amount of the binder is too much, bonding strength between alloy powder particles may be high, but soft magnetic properties are deteriorated due to less amount of amorphous alloy powder in the molded compressed powder core. Herein, ‘total weight’ means the sum of weights of the coating agent and the amorphous alloy constituting the prepared core, the weight of an organic solvent being excluded.

Molybdenum disulfide (MoS₂) or graphite powder is suitable to impart high-temperature lubricity to the amorphous alloy powder prepared by coating the binder in the present invention, and the average particle size of the powder is suitably about 1 to 10 μm.

Furthermore, it is preferable that the amount of addition is limited to 0.5 to 3.0 wt % of the total weight. When the amount is less than 0.5 wt %, a molding punch is damaged due to lack of lubricity between powders. On the other hand, when the amount is greater than 3.0 wt %, soft magnetic properties are deteriorated and economic efficiency is reduced.

Pressure during the molding of the compressed powder core in the present invention is suitably 10 to 30 ton/cm². When the molding pressure is less than 10 ton/cm², soft magnetic properties are deteriorated due to low molding density of the compressed powder core. On the other hand, when the molding pressure is too high, manufacturing unit cost increases due to frequent abrasion and breakage of a molding die.

It is preferable that temperature during the molding in the present invention is in a range of 200 to 550° C. When the molding temperature is lower than 200° C., proper molding density is not realized. As the molding temperature increases, molding density of the core and compactness between powder particles increase. However, it is preferable to mold below the crystallization temperature due to the nature of amorphous alloy powder.

Generally, crystallization temperature of most of the amorphous alloy powder is around 400 to 550° C., and it is thus preferable that the maximum molding temperature is set to be 550° C. or lower.

Heat-treatment temperature of the compressed powder core in the present invention varies depending on the amorphous alloy composition and pre-treatment temperature. However, in the case of general amorphous alloy powder systems which are not nano-crystallized, the heat-treatment temperature is suitably 350 to 500° C. which is about 50 to 100° C. lower than the crystallization temperature of the amorphous alloy. When the heat-treatment temperature of the compressed powder core is too low, internal stress generated during the molding is not sufficiently removed. On the other hand, when the heat-treatment temperature is too high, amorphous to crystalline phase transformation occurs.

Alternatively, heat-treatment of amorphous alloy powder which may be nano-crystallized should be performed in the range of the crystallization temperature. Therefore, in the present invention, the amorphous alloy was heat-treated at around the crystallization temperature so as to form nanocrystal. Such an amorphous alloy that may be nano-crystallized has very excellent soft magnetic properties compared with an amorphous alloy which is heat-treated below the crystallization temperature.

It is suitable that the heat-treatment in the present invention is performed for about 30 to 60 minutes under an inert gas or reducing gas atmosphere. When the heat-treatment time is too short, stress removal and crystallization are not sufficiently achieved. On the other hand, when the heat-treatment time is too long, productivity decreases.

### Advantageous Effects

According to the method for preparing a high-permeability amorphous compressed powder core having a small variable range of effective permeability even at a high frequency band by means of high-temperature molding, it is possible to prepare a high-permittivity amorphous compressed powder core by means of high-temperature molding, having a small variable range of effective permeability even at a high frequency band, an effective permeability of 75 or more, and a significantly small core loss, by coating twice, i.e. with phosphoric acid coating and polyimide-based coating as insulators between powders, and then compression molding at a high temperature of 200-550° C. by using molybdenum disulfide (MoS₂) or graphite powder which can be lubricated at a high temperature.

Also, according to the present invention, it is possible to prepare a high-permeability amorphous compressed powder core by means of high-temperature molding, wherein the high-permeability amorphous compressed powder core has high molding density and no surface crack after the molding of the amorphous compressed powder core, has good insulation properties among particles so as to be less dependent on frequency, and also has a small variable range of effective permeability even at a high frequency band. Therefore, the high-permeability amorphous compressed powder core can be used as a magnetic material for electric and electronic devices that are operated at a frequency band of several KHz to several tens of MHz.

### BEST MODE FOR CARRYING OUT THE INVENTION

### Example 1

In Example 1 which is the best mode for carrying out the present invention, 1,000 g of Fe_{73.5}Si_{13.5}B₉Nb₃Cu₁ amorphous alloy powder (having an average particle size of about 15 μm) promising nano-crystallization by proper heat-treatment, which was prepared by high-pressure water atomization, was subjected to primary phosphoric acid coating with a solution diluted by adding 10 g of phosphoric acid (H₃PO₄) into acetone, and then dried. The phosphoric acid coated powder was subjected to secondary coating with a solution prepared by dissolving 10 g of polyimide into a methylene chloride solution, and then dried to prepare composite particulate powder in which polyimide was uniformly coated with a thickness of about 1 μm or less on the surface of the amorphous alloy powder having an average particle size of about 15 μm. The composite particulate powder was dried, and 10 g of molybdenum disulfide (MoS₂) powder having an average particle size of 3 μm was then homogeneously mixed with the composite particulate powder.

About 2.50 g of the composite particulate powder thus mixed was automatically loaded into a molding die which had an outer diameter of 12.7 mm and an inner diameter of 7.65 mm and of which the temperature was maintained to be about 450° C. Thereafter, the composite particulate powder was molded at 10 hits per minute under a pressure of 20 ton/cm² to prepare a compressed powder core having an average height of 4.75 mm.

The compressed powder core thus molded was heat-treated for 60 minutes under an argon gas atmosphere at 550° C. to prepare a compressed powder core having a nano-crystallized internal structure. Density, whether or not cracks have been generated, and magnetic properties such as effective permeability at various frequency bands and core loss were measured for the nano-crystallized amorphous compressed powder core thus prepared. The results obtained from Examples and Comparative Examples are comprehensively shown in Table 1.

Herein, the density of the amorphous compressed powder core was obtained by dividing the actual weight of the core by the volume of the core, cracks were determined to have been generated when at least one crack was observed in manufacturing 10 amorphous compressed powder cores, and the effective permeability was measured at each frequency band using an LCR meter under an external magnetic field of 10 mOe. The core loss was measured using a BH analyzer under the condition of a frequency of 50 kHz and an induced magnetic field of 1,000 Gauss.

TABLE 1

| | | | | | Heat- | | | |
|---|---|---|---|---|---|---|---|---|
| | Amorphous | Molding | | Molding | treatment | | | Core |
| Condition | alloy | temp. | | density | temp. | Effective | Permeability | loss |
| No. | system | (° C.) | Crack | (g/cm³) | (° C.) | permeability | ratio | (mW/cc) |
| Example 1 | Fe_{73.5}Si_{13.5}B₉Nb₃Cu₁ | 450 | X | 6.10 | 550 | 185 | 0.91 | 185 |
| Example 2 | Fe_{73.5}Si_{13.5}B₉Nb₃Cu₁ | 450 | X | 6.08 | 550 | 145 | 0.95 | 160 |
| Example 3 | Fe_{73.5}Si_{13.5}B₉Nb₃Cu₁ | 450 | X | 6.05 | 550 | 140 | 0.97 | 150 |
| Example 4 | Fe_{73.5}Si_{13.5}B₉Nb₃Cu₁ | 200 | X | 5.59 | 550 | 75 | 0.98 | 220 |
| | | 300 | X | 5.64 | 550 | 87 | 0.98 | 200 |
| | | 400 | X | 5.89 | 550 | 127 | 0.97 | 170 |
| Example 5 | Fe_{73.5}Si_{13.5}B₉Nb₃Cu₁ | 450 | X | 6.05 | 570 | 174 | 0.98 | 195 |
| Example 6 | Fe₈₃Nb₇B₉Cu₁ | 450 | X | 6.05 | 570 | 135 | 0.98 | 185 |
| Example 7 | Fe₇₈Si₁₃B₉ | 400 | ◯ | 5.91 | 410 | 85 | 0.99 | 280 |
| Comparative | Fe_{73.5}Si_{13.5}B₉Nb₃Cu₁ | 450 | ◯ | 6.15 | 550 | 140 | 0.71 | 423 |
| Example 1 | | | | | | | | |
| Comparative | Fe_{73.5}Si_{13.5}B₉Nb₃Cu₁ | 450 | X | 5.45 | 550 | 115 | 0.53 | 745 |
| Example 2 | | | | | | | | |
| Comparative | Fe_{73.5}Si_{13.5}B₉Nb₃Cu₁ | 25 | X | 5.45 | 550 | 61 | 0.99 | 310 |
| Example 3 | Fe_{73.5}Si_{13.5}B₉Nb₃Cu₁ | 100 | X | 5.46 | 550 | 61 | 0.99 | 305 |

### MODE FOR CARRYING OUT THE INVENTION

### Example 2

Example 2 for carrying out the present invention followed the same procedure as in Example 1 except that the phosphoric coating was performed with 25 g of phosphoric acid. Various properties of the nano-crystallized amorphous compressed powder core thus prepared are shown in Table 1.

### Example 3

Example 3 for carrying out the present invention followed the same procedure as in Example 1 except that the solution was prepared by dissolving 20 g of polyimide into the methylene chloride. Various properties of the nano-crystallized amorphous compressed powder core thus prepared are shown in Table 1.

### Example 4

Example 4 for carrying out the present invention followed the same procedure as in Example 1 except that the molding temperature was 200° C., 300° C., and 400° C. Magnetic properties of the nano-crystallized amorphous compressed powder core thus prepared are shown in Table 1.

### Example 5

Example 5 for carrying out the present invention followed the same procedure as in Example 1 except that graphite powder having an average particle size of 5 μm was used as a lubricant.

Magnetic properties of the nano-crystallized amorphous compressed powder core thus prepared are shown in Table 1.

### Example 6

Example 6 for carrying out the present invention followed the same procedure as in Example 1 except that Fe₈₃Nb₇B₉Cu₁ amorphous alloy powder (having an average particle size of about 16 μm) prepared by high-pressure water atomization was used to mold the core and heat-treated at 560° C. which is above the crystallization temperature. Various properties of the nano-crystallized amorphous compressed powder core thus prepared are shown in Table 1.

### Example 7

Example 7 for carrying out the present invention followed the same procedure as in Example 1 except that Fe₇₈Nb₁₃B₉ amorphous alloy powder (having an average particle size of about 12 μm) prepared by high-pressure water atomization was used to mold the compressed powder core and heat-treated at 410° C. which is below the crystallization temperature. Since the amorphous alloy in Example 7 of the present invention was heat-treated below around the crystallization temperature, Example 7 is an example of the preparation of a general amorphous compressed powder core unlike the nano-crystallized amorphous compressed powder core in the above Examples 1 to 6. Various properties of the amorphous compressed powder core thus prepared are shown in Table 1.

Referring to Table 1, as molding temperature increases, molding density linearly increases up to 400° C., and above 400° C., the molding density sharply increases and effective permeability also sharply increases. It is possible to obtain effective permeability of 75 or more which was impossible to obtain in typical continuous production, and particularly above 400° C., it is possible to obtain effective permeability of 125 or more. The core loss property is also very excellent showing a value of 300 mW/cc or less, which is superior to those of general compressed powder cores such as Sendust, HF, and MPP. The permeability ratio at frequency bands of 1 MHz and 0.1 MHz is 0.90 or more and it can thus be seen that the permeability is rarely dependent on frequency. This means that it is consequently possible to use at a frequency band up to several tens of MHz.

Hereinafter, Comparative Examples of the present invention will be described in detail.

### Comparative Example 1

Comparative Example 1 followed the same procedure as in Example 1 except that the solution was prepared by dissolving 3 g of polyimide into the methylene chloride. Various properties of the nano-crystallized amorphous compressed powder core thus prepared are shown in Table 1.

### Comparative Example 2

Comparative Example 2 followed the same procedure as in Example 1 except that the phosphoric acid coating was not performed. Various properties of the nano-crystallized amorphous compressed powder core thus prepared are shown in Table 1.

### Comparative Example 3

Comparative Example 3 followed the same procedure as in Example 1 except that the molding temperature was 25° C. and 100° C. Various properties of the nano-crystallized amorphous compressed powder core thus prepared are shown in Table 1.

Referring to Table 1, when molding temperature is below 200° C., molding density cannot be greater than 5.5 g/cm³, and it is thus impossible to obtain effective permeability of 75 or more. When a single coating was performed or the amount of coating was small, some cracks were generated in the compressed powder core, and it could also be seen that insulation properties between powders in the core are deteriorated, frequency characteristics are thus significantly deteriorated, and core loss becomes significantly greater.

### INDUSTRIAL APPLICABILITY

The method for preparing a high-permeability amorphous compressed powder core having a small variable range of effective permeability even at a high frequency band by means of high-temperature molding according to the present invention, and the high-permeability amorphous compressed powder core prepared thereby, provide a soft magnetic material having high molding density and no surface crack, good insulation properties among particles so as to be less dependent on frequency, and a small variable range of effective permeability even at a high frequency band. The high-permeability amorphous compressed powder core has very excellent magnetic properties such as effective permeability and core loss compared with crystalline materials, so that the high-permeability amorphous compressed powder core is being used as a magnetic material for various electric and electronic devices that are operated at a frequency band of several KHz to several tens of MHz, and may be used for industrial applications such as transformers, inductors, motors, generators, and relays.

1. A method for preparing a high-permeability amorphous compressed powder core by means of high-temperature molding, the method comprising:
(a) performing coating twice on soft magnetic amorphous alloy powder to prepare composite particulate powder having excellent insulation properties, bonding force, and moldability between powders;
(b) mixing fine molybdenum disulfide (MoS2) or graphite powder as a high temperature lubricant with the composite particulate powder;
(c) performing automatic molding on the mixed powder at a high temperature; and
(d) performing heat-treatment on the molded composite particulate powder.

2. The method of claim 1, wherein the soft magnetic amorphous alloy powder is Fe-based powder, Ni-based powder, or Co-based powder.

3. The method of claim 1, wherein the performing of the coating twice on the soft magnetic amorphous alloy powder includes performing primary coating as phosphoric acid coating in the amount of 0.5 to 3.0 wt %, and performing secondary coating as polyimide coating in the amount of 0.5 to 3.0 wt %, based on the total weight.

4. The method of claim 1, wherein the molding is performed at a high temperature of 200 to 550° C. under a pressure of 10 to 30 ton/cm2.

5. The method of claim 1, wherein the heat-treatment is performed at a temperature of 400 to 550° C.

6. The method of claim 1, wherein the high-permeability amorphous compressed powder core has an effective permeability of 85 or more, a permeability ratio of 0.90 or more, which is measured at frequency bands of 1 MHz and 0.1 MHz, and a core loss of 300 mW/cc or less under conditions in which the frequency is 50 kHz and the induced magnetic flux is 1,000 Gauss.

7. A high-permeability amorphous compressed powder core according to the method of claim 1.

8. A high-permeability amorphous compressed powder core according to the method of claim 2.

9. A high-permeability amorphous compressed powder core according to the method of claim 3.

10. A high-permeability amorphous compressed powder core according to the method of claim 4.

11. A high-permeability amorphous compressed powder core according to the method of claim 5.

12. A high-permeability amorphous compressed powder core according to the method of claim 6.
